(19) United States
(12) Patent Application Publication
(10) Pub. No.: US 2009/0099925 A1
(43) Pub. Date: Apr. 16, 2009

(54) Apparatus and Method for Virtual World Item Searching

(76) Inventors: Kaushal N. Mehta, Fremont, CA (US); Daniel Kolkowitz, Los Altos Hills, CA (US); Peruvemba V. Subramanian, Santa Clara, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/245,655

(22) Filed: Oct. 3, 2008

Related U.S. Application Data
(60) Provisional application No. 60/997,685, filed on Oct. 4, 2007.

(51) Int. Cl. G06F 7/06; G06F 17/30; G06Q 30/00

(52) U.S. Cl. 705/14; 707/104.1; 707/3; 707/E17.014; 707/E17.044; 707/E17.108

(57) ABSTRACT

A computer implemented method to characterize virtual goods in a virtual environment includes identifying an item exchange in the virtual environment. The context of the item exchange is recorded to characterize details of the virtual environment at the time of the item exchange. The context of the item exchange is added to a repository of contexts characterizing contexts from a number of item exchanges. A request to search for a virtual item is received. The virtual item is matched to a set of items in the repository. The set of items are presented in response to the request.

### CROSS-REFERENCE TO RELATED APPLICATION

This application claims priority to U.S. Provisional Patent Application 60/997,685, filed Oct. 4, 2007, entitled “MMOG and Virtual World Item Search”, the contents of which are incorporated herein.

### FIELD OF THE INVENTION

The invention relates generally to virtual environments operated on networked computers. More particularly, the invention relates to searching for items and supplying advertisements in such virtual environments.

### BACKGROUND OF THE INVENTION

Massively multiple online games (MMOGs) are online computer games capable of supporting hundreds of thousands of simultaneous users. The users play with and against each other and can cooperate on teams or act individually. Virtual Worlds (VWs) are similar, but they differ in that users do not necessarily compete directly against each other, but instead participate in these worlds as characters; in essence, they live and act in a virtual world. In both cases, avatars are used as the virtual identities of the users.

Millions of users have created and maintain virtual identities in these MMOGs and virtual worlds. Commerce of virtual items has begun and is growing in both of these environments. Users can buy or sell currencies and items, or barter for things that they need. These items are useful to the game players or game environments or may be independent from them and just be appealing to the players. Billions of dollars are currently being spent in this market and the total market size is expected to grow rapidly.

Advertisers have also started to place ads for their “real” products and services in the games and virtual worlds. Technology has emerged which places banner ads in games and virtual worlds. These ads are seen by the actual users on their computer screens as they participate in the game or virtual world.

### SUMMARY OF THE INVENTION

The invention includes a computer implemented method to characterize virtual goods in a virtual environment. An item exchange is identified in the virtual environment. The context of the item exchange is recorded to characterize details of the virtual environment at the time of the item exchange. The context of the item exchange is added to a repository of contexts characterizing contexts from a number of item exchanges. A request to search for a virtual item is received. The virtual item is matched to a set of items in the repository. The set of items are presented in response to the request.

### BRIEF DESCRIPTION OF THE FIGURES

The invention is more fully appreciated in connection with the following detailed description taken in conjunction with the accompanying drawings, in which:

FIG. 1 illustrates a computer system configured in accordance with an embodiment of the invention.

Like reference numerals refer to corresponding parts throughout the several views of the drawings.

### DETAILED DESCRIPTION OF THE INVENTION

Virtual worlds and MMOGs have no limit on the number or kinds of items that can be created within them. These items can be considered “virtual goods” or “virtual items.” Each catalogue of virtual goods or items in a particular MMOG or virtual world might contain hundreds of thousands or millions of such virtual items. Some of the virtual items that are created may only be relevant to the particular game or VW. For example, a sword in one MMOG can have a completely different purpose or application than a sword in a different game. The present invention, according to various embodiments, provides a system for a user (i.e. a participant in MMOGs or VWs) to search for virtual goods or items that are relevant to the user; that is, relevant to the context of the user's avatar in the MMOG or VW. As such, users are able to locate what they want with a very high probability of utility. In addition, advertisers are able to target those same users with advertisements with a very high probability of the users being interested in and purchasing the advertised products or services.

As used hereinafter for the sake of convenience, both MMOGs and VWs will be referred to as MMOGs unless otherwise specifically noted since VWs can be considered role-playing games. Also, characters or virtual identities in both MMOGs and VWs are referred to as “avatars.”

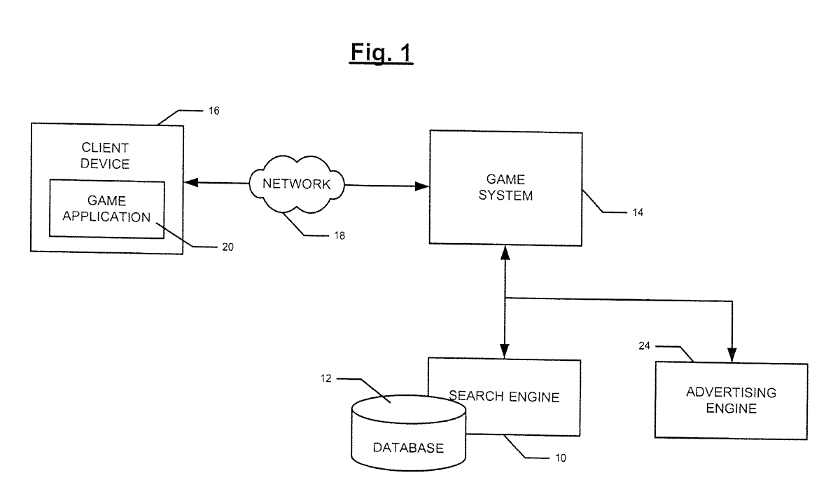

FIG. 1 is a diagram of a system for searching for virtual items according to various embodiments of the present invention. The trading system comprises a virtual item search engine 10, which may be implemented as one or a number of servers. The search engine 10 may have an associated database 12 that stores information about the virtual items. The database 12 may store data about virtual items that are available for purchase, trade, etc. Users may post virtual items for purchase, trade, etc. through any suitable virtual item exchange.

The search engine 10 may be in communication with a game system 14. A user, at client device 16, may be connected to the game system 14 through a network 18, such as the Internet, to play a MMOG provided by the game system 14. The client device 16 may have a client application 20 downloaded to it to facilitate playing of the MMOG.

According to various embodiments, when a user at client device 16 submits a search query (which may be done through a graphical interface provided by the client application 20), the context of the user's avatar in the MMOG may be recorded and used by the search engine SO to identify relevant virtual items responsive to the search query. When a transaction is made, the avatar's context and the transaction details (e.g., price, item purchased, etc.) are recorded in the database 12. That way, when responding to future search queries, the search engine 10 can examine the records for both the avatar context and the requested item to determine the most relevant item(s) for future searches. For example, whenever a user wishes to find a virtual item, the search engine 10 may examine the purchase history for similar items for avatars contexts that are the same as or similar to the avatar context of the user issuing the search query. Depending upon the match of the contexts, a ranking score can be computed by the search engine 10 that defines the probability that the user will buy (or otherwise transact for) the relevant virtual items.

In various embodiments, the search engine 10 requires that the environment of the avatar be examined and relevant attributes extracted by the search engine 10 to define the avatar's context. This can be done by hooks in the client application 20 and the game system 14 that forward the relevant environment and context information to the search engine 10. According to various embodiments, the avatar's context can be defined by the following characteristics: the particular MMOG; the avatar type; the level in the game of the player; the local context of the player in the game; the server that the player is playing on (for game systems having multiple servers); the avatar's gender; the avatar's guild (if any); and any other relevant game scenario that defines where the avatar is in the game. An example of such a scenario might be a “castle” or “cave.”

The search engine 10 may use a ranking algorithm to determine the most relevant results to the user's search query based on the avatar's context. For example, in response to a search query, the search engine 10 may search for a relevant item based on the attributes of the item being searched for. The attributes may comprise, for example: the game; levels in the game; age of the items; cost differential; purchase probability; and/or any other relevant attribute. Cost differential represents the notion that if a particular item has a much higher value in a particular context than in other contexts, its ranking should be higher when the context of the search is the context where the item has the much higher value. From this universe of relevant items, the search engine 10 may then determine the item (or items) having the highest probability of being useful to the user/avatar based on the avatar's context, as described above. That is, the search engine may compare the context of the user's avatar to the avatar context for the relevant virtual items to determine the most relevant items.

The search engine may determine the relevancy of a virtual item based on the rules which apply in the game and the history of usability of the items to the characters in the game. So, for example, if a user is searching for a sword for use in a particular game, swords which have proven to be useful to the players in the particular game in the past preferably will have a higher relevance. The score for a particular virtual item may be based on the percentage of times the purchase happens for identical and/or close contexts. In this scenario, a high score would indicate a high relevancy and a low score would indicate a low relevancy.

Referring back to FIG. 1, an advertisement server system 24 may also supply advertising data to the game system 14 to supply specific advertising materials to the user based on the avatar's context. That is, the advertisement server system 24 may have information on products (whether real or virtual) that are attractive to users having characters with certain avatar contexts. By knowing the avatar context from the search process, the advertisement sewer system 24 can provide highly-relevant advertising material to the game system 14, which may use the advertising material in the MMOG.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments. It is further to be understood that the figures and descriptions of the embodiments have been simplified to illustrate elements that are relevant for a clear understanding of the embodiments, while eliminating, for purposes of clarity, other elements.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware which may be used to implement embodiments is not limiting. For example, embodiments described herein may be implemented in computer software using any suitable computer software language type, such as, for example, C or C++ using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media. Such media may include any of the forms listed above with respect to storage devices and/or, for example, a modulated carrier wave, to convey instructions that may be read, demodulated/decoded, or executed by a computer or computer system.

It can also be appreciated that certain process aspects described herein may be performed using instructions stored on a computer-readable medium or media that a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent and/or semitemporary.

A “computer,” “computer system,” “engine,” “host,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

1. A computer implemented method to characterize virtual goods in a virtual environment, comprising:
identifying an item exchange in the virtual environment; and
recording the context of the item exchange to characterize details of the virtual environment at the time of the item exchange.

2. The computer implemented method of claim 1 further comprising:
adding the context of the item exchange to a repository of contexts characterizing contexts from a plurality of item exchanges.

3. The computer implemented method of claim 2 further comprising:
receiving a request to search for a virtual item;
matching the virtual item to a set of items in the repository; and
presenting the set of items.

4. The computer implemented method of claim 3 wherein matching includes searching for relevant items based upon item attributes.

5. The computer implemented method of claim 4 wherein the item attributes are selected from game identification, game level, item age, item cost, and purchase history.

6. The computer implemented method of claim 3 wherein receiving includes receiving an item context for the virtual item and matching includes processing the item context.

7. The computer implemented method of claim 1 wherein the context includes information selected from game identification, avatar type, game level, game server, avatar gender, and avatar guild.

8. The computer implemented method of claim 1 further comprising providing advertising information based upon the context.

9. The computer implemented method of claim 8 further comprising providing product information relevant to the context.
